(19) United States
(12) Patent Application Publication
(10) Pub. No.: US 2015/0106766 A1
(43) Pub. Date: Apr. 16, 2015

(54) METHOD FOR QUICKLY OPERATING FILE OF SMART PHONE AND SMART PHONE

(71) Applicant: ZTE Corporation, Shenzhen City (CN)

(72) Inventors: Bohao Qiao, Shenzhen City (CN); Kuihua Wang, Shenzhen City (CN)

(21) Appl. No.: 14/408,036

(22) PCT Filed: May 30, 2013
(86) PCT No.: PCT/CN2013/076439

§ 371 Date: Dec. 15, 2014

(30) Foreign Application Priority Data
Jul. 2, 2012 (CN) 201210224797.4

(51) Int. Cl. G06F 3/0484; G06F 3/0354; G06F 3/0481; G06F 3/0488; G06F 3/0482; G06F 3/0483

(52) U.S. Cl. CPC G06F 3/04842; G06F 3/0482; G06F 3/0483; G06F 3/04817; G06F 3/04883; G06F 3/03545
USPC 715/835

(57) ABSTRACT

A method for quickly operating files of a smart phone includes: the smart phone starting a file batch selection function according to an operation of a user; in a state that the file batch selection function is started, the smart phone selecting files and/or folders in corresponding positions according to a sliding track of a finger or an operation rod on a touch screen; and the smart phone performing an operation selected by the user on all selected files and/or folders. A smart phone includes: a touch screen and a file processor, wherein the file processor includes a batch selection on-off module, a file batch selection module and a file batch operation module. In the example of the present invention, the files are operated conveniently and quickly by using the touch screen of the smart phone, which has a significant effect in processing a large number of files.

### TECHNICAL FIELD

The present invention relates to the technical field of electronic communication terminal, and specifically, to a method for quickly operating files of a smart phone and a smart phone.

### BACKGROUND OF THE RELATED ART

With the development of the technology, since electronic devices, such as a smart phone, with powerful functions and large-screen touch screens appear and have started to popularize, and various files and applications are downloaded more and more in the mobile phone, thus it is required to perform frequent operations for organizing various files stored in the mobile phone. However, there is still no system and method for conveniently and quickly processing batch files by using the touch screens of the electronic devices in the related art.

### SUMMARY OF THE INVENTION

In order to solve the above technical problem, the example of the present invention provides a method for quickly operating files of a smart phone and a smart phone, so that a user can select the files through a slide of a finger or a touchpen and perform processing with the touch screens of the electronic devices.

The example of the present invention discloses a method for quickly operating files of a smart phone, which comprises:

the smart phone starting a file batch selection function according to an operation of a user;

in a state that the file batch selection function is started, the smart phone selecting files and/or folders in corresponding positions according to a sliding track of a finger or an operation rod on a touch screen; and

the smart phone performing an operation selected by the user on all selected files and/or folders.

Alternatively, the step of the smart phone selecting files and/or folders in corresponding positions according to a sliding track of a finger or an operation rod on a touch screen comprises:

detecting point coordinates of the sliding track of the finger or the operation rod on the touch screen, comparing the point coordinates and coordinates of an icon area of files and/or folders on the touch screen, and taking files and/or folders whose icon area contains at least one of the point coordinates as selected files and/or folders.

Alternatively, in the step of the smart phone selecting files and/or folders in corresponding positions according to a sliding track of a finger or an operation rod on a touch screen, the sliding track includes a sliding track generated when the finger or the operation rod slides one time or multiple times on the touch screen.

Alternatively, after the step of the smart phone selecting files and/or folders in corresponding positions according to a sliding track of a finger or an operation rod on a touch screen in a state that the file batch selection function is started, the method further comprises:

when the file batch selection function is closed according to the operation of the user, the smart phone recording the selected files and/or folders; and

when switching to another page according to the operation of the user, and re-starting the file batch selection function and selecting files and/or folders in corresponding positions according to the sliding track of the finger or the operation rod on the touch screen, the smart phone taking a union set of the files and/or folders selected this time and the files and/or folders selected and recorded previously as the currently selected files and/or folders.

Alternatively, the operation selected by the user and performed on all the selected files and/or folders is one of the following operations: “copy”, “cut”, “delete” and “deselect”.

Alternatively, the method further comprises:

the smart phone closing the file batch selection function according to the operation of the user, and in a state that the file batch selection function is closed, processing a slide of the finger or the operation rod on the touch screen according to an ordinary slide.

The example of the present invention further discloses a smart phone, which comprises a touch screen and a file processor, wherein:

the file processor comprises: a batch selection on-off module, a file batch selection module and a file batch operation module;

the batch selection on-off module is configured to: start or close a file batch selection function according to an operation of a user;

the file batch selection module is configured to: in a state that the file batch selection function is started, select files and/or folders in corresponding positions according to a sliding track of a finger or an operation rod on a touch screen; and

the file batch operation module is configured to: perform an operation selected by the user on all selected files and/or folders.

Alternatively, the file batch selection module is configured to select files and/or folders in corresponding positions according to a sliding track of a finger or an operation rod on a touch screen in the following way:

detecting point coordinates of the sliding track of the finger or the operation rod on the touch screen, comparing the point coordinates and coordinates of an icon area of files and/or folders on the touch screen, and selecting files and/or folders whose icon area contains at least one of the point coordinates as the files and/or folders in the corresponding positions.

Alternatively, when the file batch selection module selects the files and/or folders in the corresponding positions according to the sliding track of the finger or the operation rod on the touch screen, the sliding track includes a sliding track generated when the finger or the operation rod slides one time or multiple times on the touch screen.

Alternatively, the file batch selection module is further configured to: after selecting the files and/or folders in the corresponding positions according to the sliding track of the finger or the operation rod on the touch screen in the state that the file batch selection function is started, when the file batch selection function is closed according to the operation of the user, record the selected files and/or folders; and when switching to another page according to the operation of the user, and re-starting the file batch selection function and selecting files and/or folders in corresponding positions according to the sliding track of the finger or the operation rod on the touch screen, take a union set of the files and/or folders selected this time and the files and/or folders selected and recorded previously as the currently selected files and/or folders.

In the example of the present invention, the user can perform operations on the files conveniently and quickly by using the touch screen of the smart phone, which has a significant effect in processing a large number of files.

### BRIEF DESCRIPTION OF DRAWINGS

FIG. 1 is a schematic diagram of a smart phone according to the example of the present invention.

FIG. 2 is a flow diagram of a method for quickly operating files of the smart phone according to the example of the present invention.

FIG. 3 is a schematic diagram of an interface of the file processor according to the example of the present invention.

### PREFERRED EMBODIMENTS OF THE PRESENT INVENTION

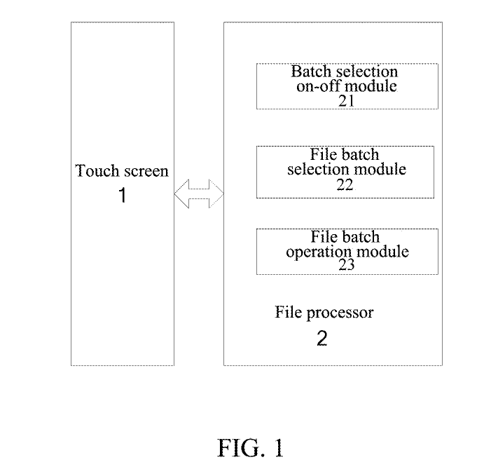

With reference to FIG. 1, the example of the present invention discloses a smart phone, which includes a touch screen 1 and a file processor 2. The file processor includes: a batch selection on-off module 21, a file batch selection module 22 and a file batch operation module 23, wherein, the batch selection on-off module 21 is configured to: start or close a file batch selection function according to an operation of a user; the file batch selection module 22 is configured to: in a state that the file batch selection function is started, select files and/or folders in corresponding positions according to a sliding track of a finger or an operation rod on a touch screen; and the file batch operation module 23 is configured to: perform an operation selected by the user on all selected files and/or folders.

The file batch selection module 22 is configured to select files and/or folders in corresponding positions according to a sliding track of a finger or an operation rod on a touch screen in the following way:

detecting point coordinates of the sliding track of the finger or the operation rod on the touch screen, comparing the point coordinates and coordinates of an icon area of files and/or folders on the touch screen, and selecting files and/or folders whose icon area contains at least one of the point coordinates as the files and/or folders in the corresponding positions.

When the file batch selection module 22 selects the files and/or folders in the corresponding positions according to the sliding track of the finger or the operation rod on the touch screen, the sliding track includes a sliding track generated when the finger or the operation rod slides one time or multiple times on the touch screen.

The file batch selection module 22 is further configured to: after selecting the files and/or folders in the corresponding positions according to the sliding track of the finger or the operation rod on the touch screen in the state that the file batch selection function is started, when the file batch selection function is closed according to the operation of the user, record the selected files and/or folders; and when switching to another page according to the operation of the user, and re-starting the file batch selection function and selecting files and/or folders in corresponding positions according to the sliding track of the finger or the operation rod on the touch screen, take a union set of the files and/or folders selected this time and the files and/or folders selected and recorded previously as the currently selected files and/or folders.

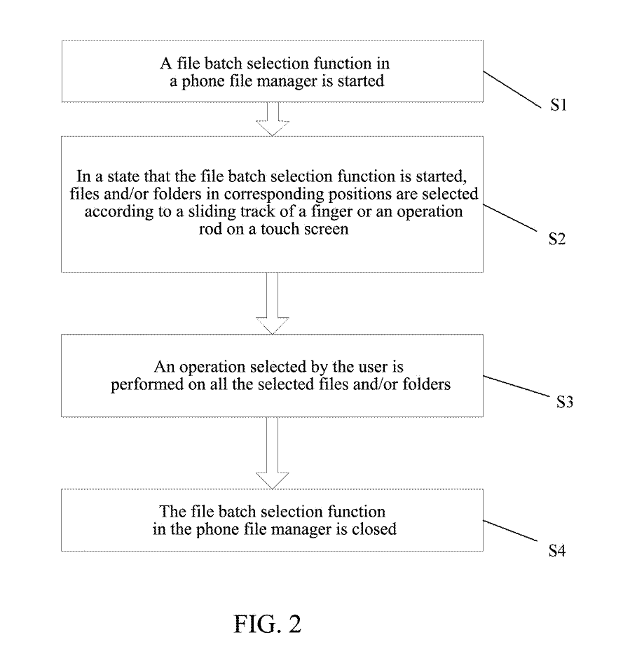

With reference to FIG. 2, the example of the present invention also discloses a method for quickly operating files of the smart phone, and the method includes the following steps.

In step S1, a file batch selection function is started according to an operation of a user.

In step S2, in a state that the file batch selection function is started, files and/or folders in corresponding positions are selected according to a sliding track of a finger or an operation rod on a touch screen.

In the step, point coordinates of the sliding track of the finger or the operation rod on the touch screen can be detected, the point coordinates are compared with coordinates of icon areas of files and/or folders on the touch screen to take files and/or folders whose icon areas contain at least one of the point coordinates as selected files and/or folders.

When selecting the files through the sliding, the user can click or slide multiple times on the touch screen. In other words, the sliding track in the step includes a sliding track generated when the finger or the operation rod slides one time or multiple times on the touch screen.

The above operation rod can be any object used for executing slide operations on the touch screen, and no limitation is made on a structural shape of the object in the technical scheme of the present invention. Moreover, in the present document, a click operation is taken as a special situation of the slide operations, that is, the slide operation whose track includes only one coordinate point.

In step S3, an operation selected by the user is performed on all the selected files and/or folders.

The operation selected by the user performed on all the selected files and/or folders can be one of the following operations: “copy”, “cut”, “delete” and “deselect”.

In step S4, the file batch selection function is closed according to the operation of the user.

In a state that the file batch selection function is closed, a slide of the finger or the operation rod on the touch screen is processed according to an ordinary slide, that is, it is processed in accordance with the existing way.

Batch processing on files selected from multiple pages can also be implemented with the above method. After files are selected in corresponding positions according to the sliding track of the finger on the touch screen in a state that the file batch selection function is started, when the file batch selection function is closed according to the operation of the user, the selected files are recorded; and when it switches to another page according to the operation of the user, and the file batch selection function is restarted and files and/or folders in corresponding positions are selected according to the sliding track of the finger on the touch screen, a union set of the files selected this time and the files selected and recorded previously are taken as the currently selected files, and the follow-up deletion, deselection or other operations can be performed after selecting the files.

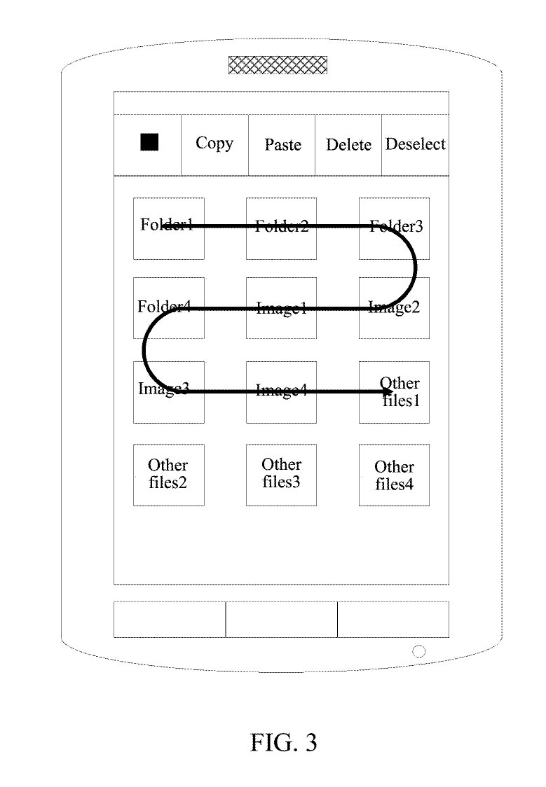

In specific operations of the user, keys corresponding to functions of the operations are marked on an interface of the file processor. With reference to FIG. 3, a file batch processing function on-off key, a copy key, a paste key, a delete key and a deselect key are marked on the interface of the file processor. There are files such as folders and images and so on in the file processor. The user slides or clicks on the positions corresponding to the files on the touch screen via the finger or the operation rod, and then it is detected whether a slide or a click of the user fall into an icon area of the files or folders. If yes, the files or folders are taken as files or folders selected by the user, the user can click the copy key at the upward side of the interface, and the files or folders selected by the user are copied. When the user wishes to deselect the selected files or folders, the deselect key at the upward side of the interface can be clicked, and the user can also perform pasting, deletion or other operations on the selected files.

The description in the present document is only the preferred examples of the present invention, which is not used to limit the present invention. The example of the present invention can have various modifications and changes for the skilled in the art. Therefore, all the modifications, equivalent substitutions, improvements and updates, etc. made within the spirit and principle of the present invention shall fall into the protection and scope of the present invention.

### INDUSTRIAL APPLICABILITY

In the example of the present invention, the user can perform operations on the files conveniently and quickly by using the touch screen of the smart phone, which has a significant effect in processing a large number of files.

1. A method for quickly operating files of a smart phone, comprising:
the smart phone starting a file batch selection function according to an operation of a user;
in a state that the file batch selection function is started, the smart phone selecting files and/or folders in corresponding positions according to a sliding track of a finger or an operation rod on a touch screen; and
the smart phone performing an operation selected by the user on all selected files and/or folders.

2. The method according to claim 1, wherein:
the step of the smart phone selecting files and/or folders in corresponding positions according to a sliding track of a finger or an operation rod on a touch screen comprises:
detecting point coordinates of the sliding track of the finger or the operation rod on the touch screen, comparing the point coordinates and coordinates of an icon area of files and/or folders on the touch screen, and taking files and/or folders whose icon areas contain at least one of the point coordinates as selected files and/or folders.

3. The method according to claim 1, wherein:
in the step of the smart phone selecting files and/or folders in corresponding positions according to a sliding track of a finger or an operation rod on a touch screen, the sliding track includes a sliding track generated when the finger or the operation rod slides one time or multiple times on the touch screen.

4. The method according to claim 1, wherein:
after the step of the smart phone selecting files and/or folders in corresponding positions according to a sliding track of a finger or an operation rod on a touch screen in a state that the file batch selection function is started, the method further comprises:
when the file batch selection function is closed according to the operation of the user, the smart phone recording the selected files and/or folders; and
when switching to another page according to the operation of the user, and re-starting the file batch selection function and selecting files and/or folders in corresponding positions according to the sliding track of the finger or the operation rod on the touch screen, the smart phone taking a union set of the files and/or folders selected this time and the files and/or folders selected and recorded previously as the currently selected files and/or folders.

5. The method according to claim 1, wherein:
the operation selected by the user and performed on all the selected files and/or folders is one of the following operations: “copy”, “cut”, “delete” and “deselect”.

6. The method according to claim 1, further comprising:
the smart phone closing the file batch selection function according to the operation of the user, and in a state that the file batch selection function is closed, processing a slide of the finger or the operation rod on the touch screen according to an ordinary slide.

7. A smart phone, comprising a touch screen and a file processor, wherein:
the file processor comprises: a batch selection on-off module, a file batch selection module and a file batch operation module;
the batch selection on-off module is configured to: start or close a file batch selection function according to an operation of a user;
the file batch selection module is configured to: in a state that the file batch selection function is started, select files and/or folders in corresponding positions according to a sliding track of a finger or an operation rod on a touch screen; and
the file batch operation module is configured to: perform an operation selected by the user on all selected files and/or folders.

8. The smart phone according to claim 7, wherein:
the file batch selection module is configured to select files and/or folders in corresponding positions according to a sliding track of a finger or an operation rod on a touch screen in the following way:
detecting point coordinates of the sliding track of the finger or the operation rod on the touch screen, comparing the point coordinates and coordinates of an icon area of files and/or folders on the touch screen, and selecting files and/or folders whose icon areas contain at least one of the point coordinates as the files and/or folders in the corresponding positions.

9. The smart phone according to claim 7, wherein:
when the file batch selection module selects the files and/or folders in the corresponding positions according to the sliding track of the finger or the operation rod on the touch screen, the sliding track includes a sliding track generated when the finger or the operation rod slides one time or multiple times on the touch screen.

10. The smart phone according to claim, wherein:
the file batch selection module is further configured to: after selecting the files and/or folders in the corresponding positions according to the sliding track of the finger or the operation rod on the touch screen in the state that the file batch selection function is started, when the file batch selection function is closed according to the operation of the user, record the selected files and/or folders; and when switching to another page according to the operation of the user, and re-starting the file batch selection function and selecting files and/or folders in corresponding positions according to the sliding track of the finger or the operation rod on the touch screen, take a union set of the files and/or folders selected this time and the files and/or folders selected and recorded previously as the currently selected files and/or folders.

11. The method according to claim 2, wherein:
after the step of the smart phone selecting files and/or folders in corresponding positions according to a sliding track of a finger or an operation rod on a touch screen in a state that the file batch selection function is started, the method further comprises:
when the file batch selection function is closed according to the operation of the user, the smart phone recording the selected files and/or folders; and
when switching to another page according to the operation of the user, and re-starting the file batch selection function and selecting files and/or folders in corresponding positions according to the sliding track of the finger or the operation rod on the touch screen, the smart phone taking a union set of the files and/or folders selected this time and the files and/or folders selected and recorded previously as the currently selected files and/or folders.

12. The method according to claim 3, wherein:
after the step of the smart phone selecting files and/or folders in corresponding positions according to a sliding track of a finger or an operation rod on a touch screen in a state that the file batch selection function is started, the method further comprises:
when the file batch selection function is closed according to the operation of the user, the smart phone recording the selected files and/or folders; and
when switching to another page according to the operation of the user, and re-starting the file batch selection function and selecting files and/or folders in corresponding positions according to the sliding track of the finger or the operation rod on the touch screen, the smart phone taking a union set of the files and/or folders selected this time and the files and/or folders selected and recorded previously as the currently selected files and/or folders.

13. The method according to claim 2, wherein:
the operation selected by the user and performed on all the selected files and/or folders is one of the following operations: “copy”, “cut”, “delete” and “deselect”.

14. The method according to claim 3, wherein:
the operation selected by the user and performed on all the selected files and/or folders is one of the following operations: “copy”, “cut”, “delete” and “deselect”.

15. The method according to claim 2, further comprising:
the smart phone closing the file batch selection function according to the operation of the user, and in a state that the file batch selection function is closed, processing a slide of the finger or the operation rod on the touch screen according to an ordinary slide.

16. The method according to claim 3, further comprising:
the smart phone closing the file batch selection function according to the operation of the user, and in a state that the file batch selection function is closed, processing a slide of the finger or the operation rod on the touch screen according to an ordinary slide.

17. The smart phone according to claim 8, wherein:
when the file batch selection module selects the files and/or folders in the corresponding positions according to the sliding track of the finger or the operation rod on the touch screen, the sliding track includes a sliding track generated when the finger or the operation rod slides one time or multiple times on the touch screen.

18. The smart phone according to claim 8, wherein:
the file batch selection module is further configured to: after selecting the files and/or folders in the corresponding positions according to the sliding track of the finger or the operation rod on the touch screen in the state that the file batch selection function is started, when the file batch selection function is closed according to the operation of the user, record the selected files and/or folders; and when switching to another page according to the operation of the user, and re-starting the file batch selection function and selecting files and/or folders in corresponding positions according to the sliding track of the finger or the operation rod on the touch screen, take a union set of the files and/or folders selected this time and the files and/or folders selected and recorded previously as the currently selected files and/or folders.
